(19) United States
(12) Patent Application Publication
(10) Pub. No.: US 2003/0220822 A1
(43) Pub. Date: Nov. 27, 2003

(54) Medical information registration and retrieval apparatus and method regular

(75) Inventors: Barry J. Fiala, Somerville, TN (US); Diana L. Cowden, Somerville, TN (US)

Correspondence Address: Russell H. Walker, Walker, McKenzie & Walker, P.C., Suite 434, 6363 Poplar Avenue, Memphis, TN, 38119-4896, US

(73) Assignee: Barry Fiala Enterprises I, LLC, Memphis, TN

(21) Appl. No.: 10/444,168

(22) Filed: May 21, 2003

Related U.S. Application Data
(60) Provisional application No. 60/382,904, filed on May 22, 2002.

(51) Int. Cl. G06F 17/60

(52) U.S. Cl. 705/3

(57) ABSTRACT

Method and apparatus for registration and retrieval of medical information from a subscriber's database. A subscriber purchases database storage and enters medical information. In some embodiments, a card or a bracelet or a necklace or clothing or a tattoo, providing an access PIN and instructions, allows medical professionals to access the medical information. The subscriber's pharmaceutical purchases, prescriptions, and dosages can be automatically updated into the database. Various types of point-of-sale activation of the database are described. Other documents, such as wills, non-resuscitation instructions, etc., can be entered into the database. Access of the database is preferably by a fax-on-demand system, with access controlled by the access PIN.

### CROSS REFERENCE TO RELATED APPLICATIONS

This application is a non-provisional application corresponding to U.S. Provisional Application 60/382,904 (filed May 22, 2002) entitled “Medical Information Registration and Retrieval Apparatus and Method”, fully incorporated herein by reference, and claims priority benefit thereof.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to storage and retrieval of information related to a person's medical history, etc., and in particular, to apparatus and a method for purchase and activation of a medical information database account and for entry thereinto and retrieval therefrom of the person's medical information.

2. Information Disclosure Statement

During a medical emergency, a person may not be able to provide medical information and a medical profile to a physician or emergency care provider, perhaps because the person is unconscious or disoriented. Well-known solutions for this problem include medical information cards that a person may carry in his or her wallet or purse, but such information quickly becomes outdated, and the patient's personal physician may not be available for consultation during such an emergency.

It is therefore desirable to have apparatus and a method that provides for purchase and activation of a medical information database account, and that also provides for retrieval of a person's medical information from that database account by a physician or an emergency care provider.

Fiala et al., U.S. Pat. No. 5,918,909, issued Jul. 6, 1999, fully included herein by reference, describes novel methods and various novel embodiments for activating a metered account at a point of sale, and also discloses use of Personal Identification Numbers (“PINs”) to access the metered account after activation.

Byrne, United Kingdom Patent Application GB 2 281 714, published Mar. 15, 1995, fully included herein by reference, describes a carrier panel having one or more detachable subsidiary panels, each with machine-readable bar codes, optical character recognition (“OCR”) characters, or magnetic stripes thereon, with data being encoded into the bar codes, OCR characters, or magnetic stripes. A reader/printer apparatus reads data from the card and transcribes the data onto a subscriber application form.

Warther et al., U.S. Pat. No. 4,978,146, issued Dec. 18, 1990, fully included herein by reference, also describes a planer carrier panel having one or more detachable subsidiary panels, with machine-readable bar codes and numerical codes on the panels.

Goade, Sr., U.S. Pat. No. 5,720,158, issued Feb. 24, 1998, fully included herein by reference, and Goade, Sr., U.S. Pat. No. 5,921,584, issued Jul. 13, 1999, fully included herein by reference, describe a laminated card carrier having a card formed with and selectively detachable from the card carrier, and the card is shown having bar codes and a magnetic stripe thereon.

Smith et al., U.S. Pat. No. 5,777,305, issued Jul. 7, 1998, a card carrier package holding a prepaid debit card, with the package having a magnetic activation stripe thereon and having an aperture through the package through which a bar code and numbers on the debit card can be seen. Machine-readable marking (the bar code or the magnetic stripe) is scanned at a point-of-sale by scanning apparatus, and information is transmitted to a remote host computer.

None of these references, either singly or in combination, disclose or suggest the present invention.

### BRIEF SUMMARY OF THE INVENTION

The present invention permits an individual to have his or her personal medical profile available to a physician, or health care provider in the event of a medical emergency. A feature of the invention is that the information can be retrieved in a format that can be used in an emergency when the individual is not either conscious or in a state such that a clear disclosure of his or her medical profile can not be obtained with accuracy. The invention provides that a subscriber purchase space for storage of the information in a database. The subscriber provides the information placed in the database. The subscriber can authorize his or her physician, or pharmacy, or any other medical organization, to include in the database any personal information relevant to the individual.

The information can then be retrieved by the use of a Personal Identification Number (“PIN”). This Personal Identification Number represents a secure account number used to identify and access stored medical profile information relating to the subscriber. The PIN, which is used as an access code for the medical profile, can be found on a card that is carried by the subscriber, as shown in FIG. 5. The PIN can also be on a piece of purchased jewelry or article of clothing carried by the subscriber, as shown in FIGS. 1A, 1B, and 2. The card contains information explaining that a database containing the personal medical profile of the card holder is available if required. The PIN can also be tattooed onto the body of the person if requested, as shown in FIG. 3. The card or other item containing the PIN will also have a toll-free telephone number (i.e., a so-called “800 number”) provided. Once this toll-free telephone number is called, pre-recorded directions will instruct the caller to enter the PIN to authorize the delivery of the medical profile. A means of further protecting the secure medical profile is an additional number or required password such as the last four numbers of the individual's Social Security number.

Once the correct instruction is provided, the database can be accessed. A well-known Integrated Voice Recognition (“IVR”) apparatus that can recognize a vocabulary of spoken words, or a human customer service representative, would instruct the caller to provide a telephone number of a facsimile receiving machine located at the caller's location caller or at a medical facility, so that information could be transmitted from the database to that facsimile machine. Once determined that this is a secure fax and the proper PIN and or password has been provided, the profile would be transmitted to the facsimile machine in a print format that could be included with the individual's medical chart or file history.

### BRIEF DESCRIPTION OF THE SEVERAL VIEWS OF THE DRAWING

FIGS. 1A and 1B are perspective views of a bracelet having indicia thereon describing how to access the medical profile database.

FIG. 2 is a view of a necklace having indicia thereon describing how to access the medical profile database.

FIG. 3 is a view of tattooed indicia on an individual describing how to access the medical profile database.

FIG. 4 shows activation at a Point-of-Sale of a card attached to a package.

FIG. 5 is a view of a medical profile card as could be carried by an individual, describing how to access the medical profile database.

FIG. 6 is a schematic block diagram showing activation of the medical profile account at a point of purchase, showing online entry of data into the database, showing access of the database via fax-on-demand, showing access of the database via a kiosk, and showing information being uploaded into the database from a scanner or facsimile transmitting apparatus.

### DETAILED DESCRIPTION OF THE INVENTION

Referring to FIGS. 1A, 1B, and 2 through 6, the present invention can now be described.

The present invention provides membership/subscription to a customer-supplied medical information database that could be purchased online over the internet through a web site using a credit card, an electronic check, or other payment method, allowing immediate setup. The customer is purchasing space in a database stored, for example, in a well-known computer 10 to store his or her Medical Profile, which would include pertinent information needed when seeking healthcare or healthcare services. A preferred method used to provide these products is that of a card 18 and package 19. The package 19 advertises the product and the card 18 contains an obscured or hidden Personal Identification Number (“PIN”) 20, obscured by the package, or by overprinting, or by an obscuring sticker 22, or by a deposited scratch-off material. The card 18 further includes instructions 24 that enable a medical technician to retrieve the medical profile. The PIN 20 included on the card 18 can be activated at the register by various activation means that are discussed herein. The obscured PIN 20 on the card 18 is designed to be carried on the person in the event of an emergency or need for personal medical profile. Each Medical Profile would be privacy-secured through the use of the purchaser's account number and PIN 20.

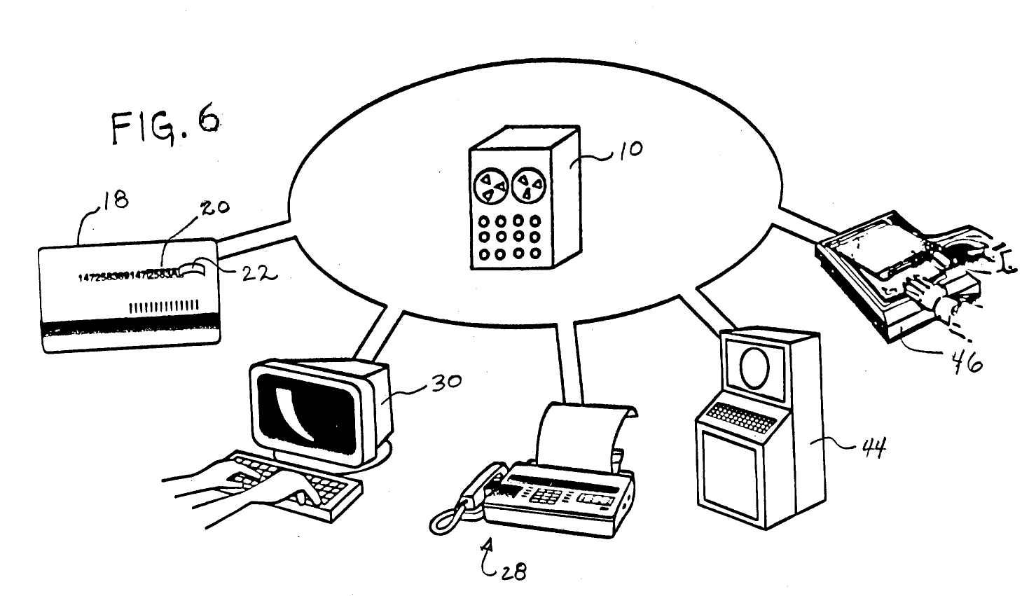

Yearly renewals of archived account information could be handled in any known fashion but the greatest benefit to the issuing retailer would be an in-store recharge of the account, by which the retailer renews the database account for an additional period of time upon payment of a renewal fee by the purchaser. The card with the secure PIN 20 is printed with the brand or name of the store at which it was purchased. This retail branding feature would create incentive for customers to remain loyal to the issuing retailer or pharmacy, as by linking current medical prescription history to the medical profile with customer authorization. The customer then would have a reason to purchase all of his or her prescriptions from a pharmacy able to automatically link those prescription purchases to the purchaser's medical profile. Current prescription medication and dosages used by the patient would be valuable information in an emergency room situation involving a life-saving procedure. The account card 18 shown in FIG. 6 would be swiped at a pharmacy, and new prescription (R_{X}) information would go directly to the database account in computer 10 for updating of the database.

A featured benefit to the retailer of the Point-of-Sale (“POS”) activated packaged product 16 is that of security from theft prior to purchase, because the product is useless until activated. The POS-activated card 18 also offers high quality printed packaging to tell the sales story. This PIN and card combination 16 also offers the option to provide prepaid telephone minutes for the customer by using a provided toll-free (“800”) number and entering the PIN number for use in case of an emergency. Each packaged product 16 serves as a sales representative for the product. The package 16 would be placed in the aisles and the checkout lanes of retail establishments. Because the activation process can record the date and time of activation, the POS-activated product 16 creates a date stamp for use in determining the beginning of the subscription and the use of the provided phone time.

The invention, however, does not require POS activation. An obscured PIN with instructions to visit a web site to register and create the profile, or to call a toll-free telephone number to begin the subscription, is an additional option. A key element of the invention is a personal medical profile information database stored in a computer 10 where current medical history 26 is supplied by the customer and could also have links to pharmacy databases to include recently-prescribed medication. In the event of a medical emergency, the physician or emergency medical technician would be instructed 24 by the card (or otherwise, for the various embodiments) to call a published toll-free telephone number and enter the PIN 20 and then the emergency room (“ER”) fax number would be requested. Within a short period of time, the fax-on-demand service would transmit the medical profile to a well-known facsimile receiver 28 for the benefit of the medical technician and the customer in a form that could be readily attached or included with the patient chart.

Individuals would have the option of setting up their medical profile information online over the internet through the use of the graphic templates provided on a web page accessed using a well-known internet browser on a well-known computer terminal 30. They would also be able to update their profile in a matter of minutes online. Customer Service Representatives would be available by telephone to assist those without online access to set up their account and update as necessary. Individuals could also request their doctor's nurse or assistant to update their medication list or other information over the internet at the time of their office visit. This would only take a matter of minutes.

A beneficial feature for this product would include branding the information to certain retail pharmacies. A national retail pharmacy, such as, for example, Walgreen's, could retail this invention in their stores. By co-ordination with the operator of the medial profile database, the retail pharmacy could offer to its customers the capability to instruct the pharmacy's host computer system to add all recently purchased medications going back as far as the customer would authorize. A period of time to consider would be to include only the non-expired medications.

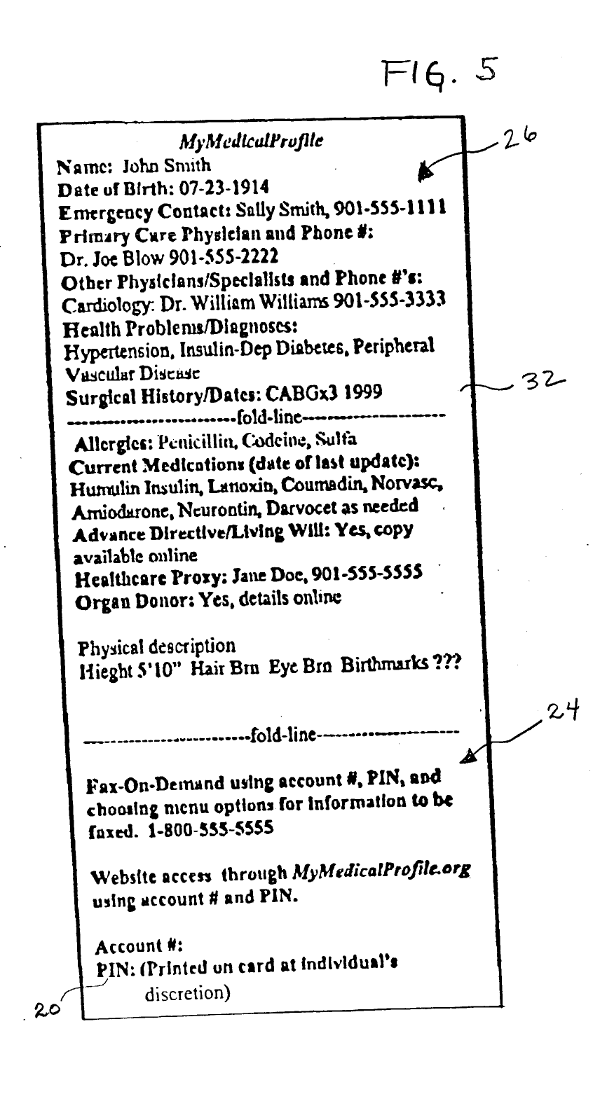

A wallet-sized card 32, such as shown in FIG. 5, could be output and printed immediately for the individual to carry with them or to be given to his or her family members/caregiver. Members would be encouraged to purchase card-stock paper for printing. If unable to print the card for themselves, cards could be printed and mailed the next business day from the home office.

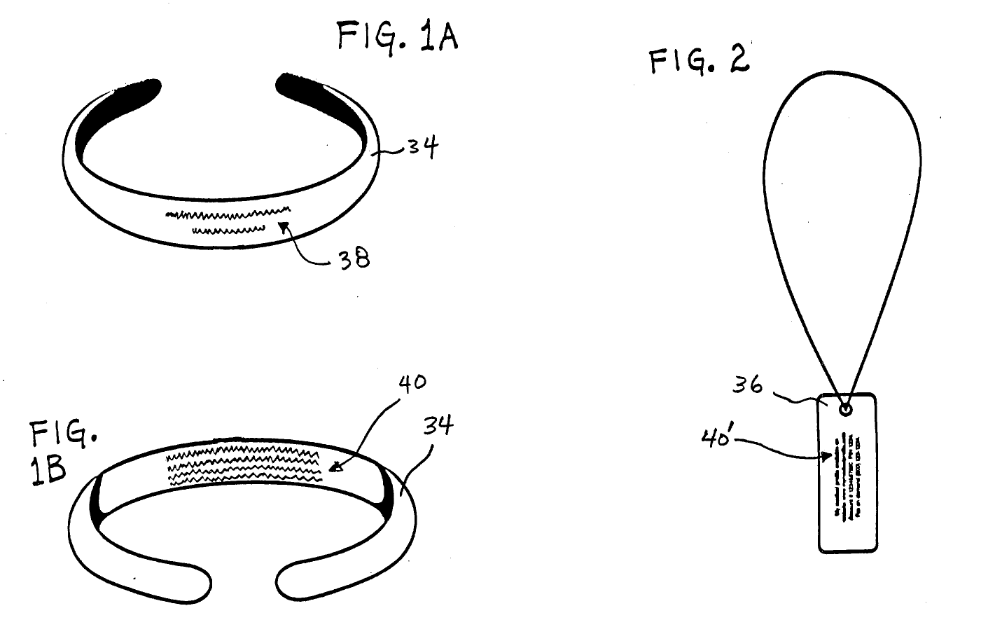

Individuals would also have the ability to purchase identification (“ID”) bracelets 34 or necklace pendants 36 bearing instructions on accessing their medical profile through the web or through a fax-on-demand option, as shown in FIGS. 1A, 1B, and 2. The bracelet 34 shown in FIGS. 1A and 1B preferably would have a visible alerting notice 38 such as:

Important medical information

See reverse side.

on the exterior of bracelet 34, directing emergency health care workers to medical profile access instructions 40 preferably located on the interior of the bracelet, such as:

My medical profile available on website www.mymedicalprofile.com

Account #1234567890 PIN 1234.

Fax on demand (800) 123-1234.

Likewise, the necklace pendant 36 shown in FIG. 2 preferably has similar medical profile access instructions 40′ thereon, such as:

My medical profile available on website www.mymedicalprofile.com

Account #1234567890 PIN 1234.

Fax on demand (800) 123-1234.

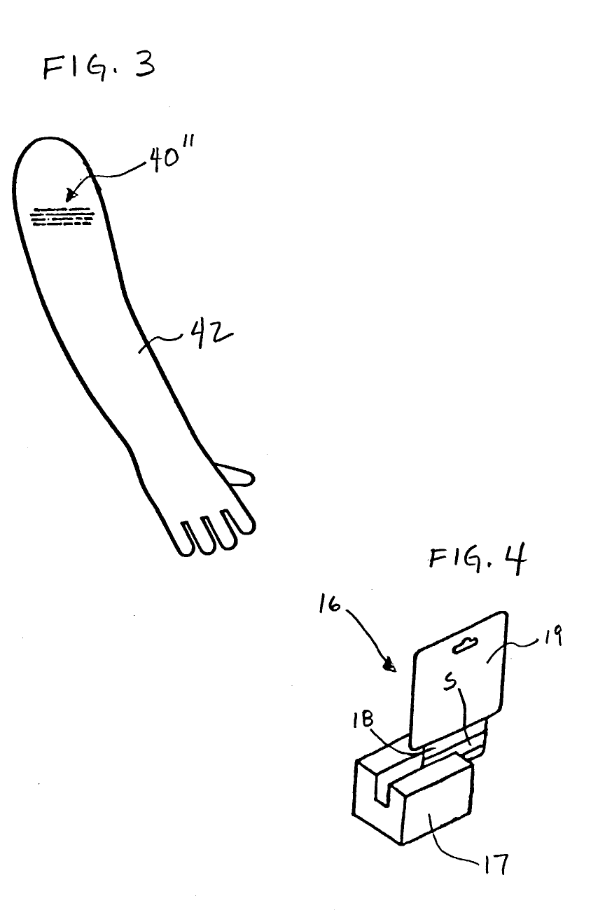

As still another embodiment of the invention, medical profile access instructions 40″ would be tattooed onto the individual as shown in FIG. 3 on a portion 42 of the individual's body. These instructions 40″, as with other embodiments, would be such as:

My medical profile available on website www.mymedicalprofile.com

Account #1234567890 PIN 1234.

Fax on demand (800) 123-1234.

These instructions 24, 40, 40′, 40″ would provide a way for emergency health care workers to immediately access vital medical information if the individual was unable to communicate or if the individual's identity was unknown. It would also assist in the cases where an individual taking numerous medications is not able to remember details in times of stress.

An individual could also upload copies of other pertinent health/legal documents to his or her account with a notation on his or her printed card of the accessibility to them through the web site or by Fax on demand. Such other documents could include: Do Not Resuscitate (“DNR”) instructions, Advanced Directive/Living Will, Healthcare Proxy, Organ Donation preference, to name a few. Upload could be accomplished through a well-known document scanner 46 or facsimile transmitter, or by attaching the documents to email sent from computer terminal 30.

This invention is preferably a point-of-sale activated package 16 with a data encoded magnetic stripe S and related bar codes or human-readable control number. This data can either be on a card 18 or on a package 19. Once purchased, the PIN or PINs associated with the encoded data are activated within the host system or platform 10 by use of a hardware activation device 17 at the register. The activation device 17 would either read the data on the magnetic stripe S, read a bar code with a bar code reader, or have the cashier or other personnel key information into a device or register, a human readable code, or activation well-known so-called integrated circuit card (“ICC”) or “smart card” technology in which data within an integrated circuit is accessed at the point-of-purchase by a well-known ICC interface apparatus. All of these methods of point-of-sale activation have the express purpose of activating a related PIN or PINs within a database in the remote data storage facility 10.

After purchase and activation, the customer or purchaser of the active PIN or PINs, by accessing an appropriate device such as a kiosk 44 or internet web site via a computer terminal 30 and providing the active PIN or PINs 20, provides requested personal information to complete the registration. Once the initial registration and presentation of an activated PIN 20 or personal access number have been processed, the individual receives access to a data entry screen, at which time personal medical information 26 relating to that individual is entered and stored for use by the medical professional or insurance provider within the database. The individual can also enter any identifying information such as scars, tattoos, etc., into the medical information database to enable positive identification of the individual by an emergency medical technician. Once the form is completed by the individual, the data or information allows for the use of the personal information by the medical industry or insurance industry. The PIN 20 on the card 18 or package products 19 provide a secure method of delivering the digital profile information over the internet, satellite communications, cable, fiber optics and all means of communications available today.

The preferred initial method of retrieval for individual personal medical history would be by a simple fax-on-demand via a well-known facsimile receiver 28. Internet availability is an option with which the product is completely compatible. The provided card 18, or other products that identify the person as a subscriber to My Medical Profile personnel, would instruct the nurse or doctor to call the indicated toll-free (“800”) telephone number. The caller would then be prompted to identify the type of information requested. An example prompt would be to “enter number three for Mr. John Doe's medical profile.” The voice prompt would then assure the medical technician that all information other than linked prescription information has been prepared and provided by Mr. Doe unless otherwise noted.

In one embodiment, kiosks 44 could be provided at the retail sites for purchasers to enter their information after purchasing the product. The kiosk 44 could also have the capability of taking a digital photo of the individual to be included on the card and the fax-on-demand for identification.

The kiosk 44 could provide the printed version 32 of the card shown in FIG. 5 and also allow future access for updating the medical profile. The customer purchases the product, goes to the kiosk 44 and registers after entering the PIN 20. The customer, at that time, has the ability to personally authorize the pharmacy retailer to provide all current medication information to the database 10, either by directly accessing the database or by having the option to email or fax the information to the database.

Although the present invention has been described and illustrated with respect to a preferred embodiment and a preferred use therefor, it is not to be so limited since modifications and changes can be made therein which are within the full intended scope of the invention.

We claim:

1. A medical information registration and retrieval method comprising the steps of:
(a) providing a medical information database for storing medical profiles of a plurality of individuals on a computer system;
(b) associating each medical profile with a different PIN by which access may be made to its associated medical profile, said access being blocked prior to activation of said access for said PIN;
then, for a given PIN of said different PINs,
(c) activating said access for said PIN of its associated medical profile;
(d) providing an individual with indicia being a physical representation of access instructions for said associated medical profile;
(e) updating said associated medical profile with specific medical information supplied for said individual; and
(f) accessing said associated medical profile using said access instructions.

2. The method as recited in claim 1, in which said step of activating said access for said PIN occurs at a point-of-sale at which a subscription to said database is purchased.

3. The method as recited in claim 1, in which said step of activating said access for said PIN occurs by said individual using an internet browser connecting to a registration web page over the internet.

4. The method as recited in claim 1, in which said step of activating said access for said PIN occurs at a kiosk in communication with said computer system.

5. The method as recited in claim 4, in which a photograph is taken of said individual at said kiosk and is stored with said associated medical profile for subsequent access.

6. The method as recited in claim 1, in which said provided indicia is on a bracelet.

7. The method as recited in claim 1, in which said provided indicia is on a pendant.

8. The method as recited in claim 1, in which said step of providing an individual with said indicia comprises tattooing said indicia onto said individual.

9. The method as recited in claim 1, in which said provided indicia is on a card.

10. The method as recited in claim 1, in which said step of accessing of said associated medical profile includes transmitting said medical profile from said database to a facsimile receiver.

11. The method as recited in claim 1, in which said step of updating said associated medical profile comprises providing a history of said individual's purchased medications within said medical profile as said medications are purchased at a retailer.

12. The method as recited in claim 1, in which said step of updating said associated medical profile comprises providing a record of said individual's visits to a physician.

13. The method as recited in claim 1, in which said step of updating said associated medical profile comprises storing a document with said associated medical profile for subsequent retrieval, said document being selected from the group consisting of a Do Not Resuscitate directive, a Living Will, a Healthcare Proxy, and an Organ Donation Preference.
